(19) United States
(12) Patent Application Publication
(10) Pub. No.: US 2009/0146960 A1
(43) Pub. Date: Jun. 11, 2009

(54) COMPUTER KEYBOARD HAVING AN ENHANCED ERGONOMIC AND INTUITIVE DESIGN

(76) Inventor: Sune Gim, Fullerton, CA (US)

Correspondence Address: Sune Gim, 2451 Applewood Circle, Fullerton, CA, 92833, US

(21) Appl. No.: 11/950,789

(22) Filed: Dec. 5, 2007

(51) Int. Cl. H04N 5/33; H04N 5/225

(52) U.S. Cl. 345/172; 345/168

(57) ABSTRACT

A keyboard apparatus for use with a computing device is presented. The apparatus includes a plurality of alphanumeric keys grouped into at least a left group for use by a user's left hand and a right group for use by a user's right hand. A touchpad device for controlling a movement of a cursor displayed on the computing device by a touch movement on a surface of the touchpad is positioned between the left group and the right group for easy and intuitive access when using the alphanumeric keys. Designated keys for activating functions on the computing device when the touch movement is controlling the cursor are provided where minimal movement is required of the user's hands for the touch movement and the function activating

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally keyboards. More particularly, the invention relates to a computer keyboard with an integrated touchpad providing an ergonomic design and intuitive function.

### BACKGROUND OF THE INVENTION

Discomfort may be experienced by a user of a typical keyboard or mouse generally in the hands and wrists. Furthermore, many people suffer from carpal tunnel syndrome (CTS) or tendonitis caused by prolonged mouse and standard keyboard use. Currently ergonomically curved style keyboards are available to relieve some of this discomfort and some CTS and tendonitis issues. However, most users of ergonomic keyboards also use a mouse, which also contributes to the problem of hand and wrist discomfort, CTS, and tendonitis. Using a touchpad rather than a mouse can alleviate some of this discomfort, especially if this touchpad is placed in an ergonomic location. However, the layout of currently known keyboards with touch pads is not ergonomic or intuitive. In a typical keyboard with a touchpad, for example without limitation a typical laptop keyboard, the touchpad is generally placed above or below the standard keyboard layout requiring the user to move his hand back and forth between the keyboard and the touchpad when in use.

In view of the foregoing, there is a need for an improved keyboard with an integrated touchpad that is ergonomic and intuitive in design.

### BRIEF DESCRIPTION OF THE DRAWINGS

The present invention is illustrated by way of example, and not by way of limitation, in the figures of the accompanying drawings and in which like reference numerals refer to similar elements and in which:

The present invention is best illustrated by way of example, and not by way of limitation, in the figures of the accompanying drawings and in which like reference numerals refer to similar elements and in which:

FIG. 1 illustrates an exemplary straight keyboard with an integrated touchpad, in accordance with an embodiment of the present invention;

FIG. 2 illustrates an exemplary ergonomic curved keyboard with an integrated touchpad, in accordance with an embodiment of the present invention;

FIG. 2A illustrates an exemplary ergonomic curved keyboard with an integrated touchpad, in accordance with an embodiment of the present invention but right portion keyboard that has the function keys, and numeric keys on the right side is straightened instead of remaining curved.

FIG. 3 illustrates an exemplary keyboard embodiment with the addition of a scroll buttons in accordance with an embodiment of the present invention;

FIG. 4 illustrates an exemplary keyboard with programable function buttons in accordance with an embodiment of the present invention; and

FIG. 5 illustrates an exemplary keyboard with a calculator in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a computer keyboard having an enhanced ergonomic and intuitive design is presented.

In one embodiment, a keyboard apparatus for use with a computing device is presented. The apparatus includes a plurality of alphanumeric keys grouped into at least a left group for use by a user's left hand and a right group for use by a user's right hand. A touchpad device for controlling a movement of a cursor displayed on the computing device by a touch movement on a surface of the touchpad is positioned between the left group and the right group for easy and intuitive access when using the alphanumeric keys. Designated keys for activating functions on the computing device when the touch movement is controlling the cursor are provided where minimal movement is required of the user's hands for the touch movement and the function activating. Another embodiment further includes a left spacebar key positioned left of the touchpad and a right spacebar key positioned right of the touchpad for entering spaces during alphanumeric entry into the computing device. Other embodiments further include a left scroll button proximate a left side of the touchpad and a right scroll button proximate a right side of the touchpad for activating a scrolling function of a display on the computing device and a left scroll touchstrip pad proximate a left side of the touchpad and a right scroll touchstrip pad proximate a right side of the touchpad for activating a scrolling function of a display on the computing device by a touch movement on the left or right scroll touchstrip pad. Yet other embodiments further include programmable function buttons proximate the sides of the touchpad for activating functions on the computing device and a calculator for performing basic mathematical functions and displaying results thereof on the apparatus. In still another embodiment the designated keys are arrow keys. In other embodiments the alphanumeric keys are generally arranged in a QWERTY format, the touchpad is positioned between a left line of alphanumeric keys including 6, T, G, and B keys and a right line of alphanumeric keys including 7, Y, H, and, N keys and the designated keys are either the S, D, and F keys or the J, K, and L keys. In this example, these keys represent the left, middle and right click buttons on a mouse. In yet other embodiments a height of the touchpad is at least a height of rows of the alphanumeric keys and the touchpad is square. In still another embodiment rows of the alphanumeric keys are arranged on a curve.

In another embodiment a keyboard apparatus for use with a computing device is presented. The apparatus includes means for providing a plurality of alphanumeric keys, means for controlling a movement of a cursor displayed on the computing device by a touch movement and means for activating functions on the computing device when the touch movement is controlling the cursor where minimal movement is required of a user's hands for the controlling means and the functions means. Yet other embodiments further include means for entering spaces during alphanumeric entry into the computing device, means for activating a scrolling function of a display on the computing device, means for providing programmable function buttons for activating functions on the computing device and means for performing basic mathematical functions and displaying results thereof on the apparatus.

In another embodiment a keyboard apparatus for use with a computing device is presented. The apparatus includes a plurality of alphanumeric keys generally arranged in a QWERTY format grouped into at least a left group for use by a user's left hand and a right group for use by a user's right hand. A touchpad device for controlling a movement of a cursor displayed on the computing device by a touch movement on a surface of the touchpad is positioned between a left line of alphanumeric keys including 6, T, G, and B keys and a right line of alphanumeric keys including 7, Y, H, and, N keys for easy and intuitive access when using the alphanumeric keys. A left spacebar key is positioned left of the touchpad and a right spacebar key is positioned right of the touchpad for entering spaces during alphanumeric entry into the computing device. A left scroll means proximate a left side of the touchpad and a right scroll means proximate a right side of the touchpad for activating a scrolling function of a display on the computing device is included. Programmable function buttons proximate the sides of the touchpad for activating functions on the computing device is included. Designated keys for activating functions on the computing device when the touch movement is controlling the cursor are provided where minimal movement is required of the user's hands for the touch movement and the function activating. In still another embodiment the designated keys are either the S, D, and F keys or the J, K, and L keys.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

The present invention is best understood by reference to the detailed figures and the description set forth herein.

The preferred embodiment of the present invention provides a keyboard with an integrated touchpad that provides easier and more intuitive access to the touchpad because the touchpad is centered between the keys of the keyboard. In some embodiments, the keyboard may also be ergonomically designed. In the preferred embodiment, the hands of the user do not have to leave the keyboard in order to utilize the left or right click functions of the touchpad.

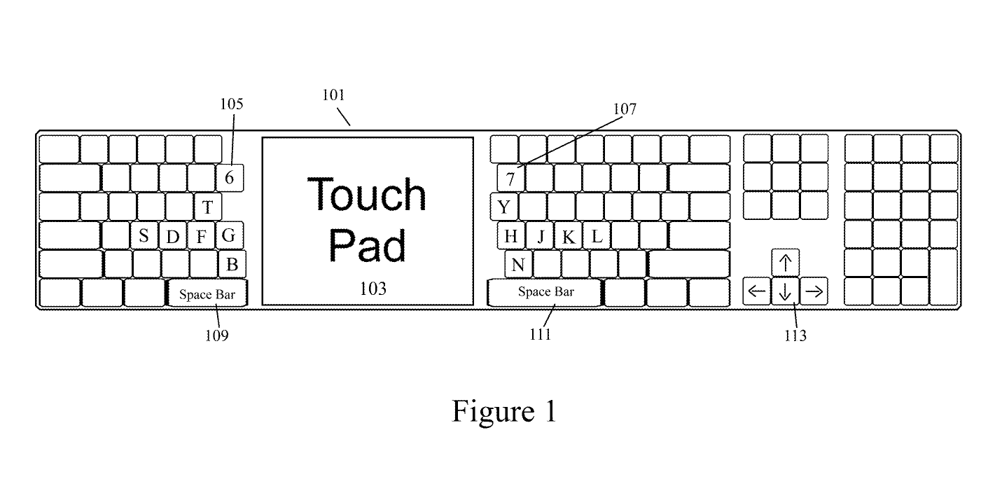

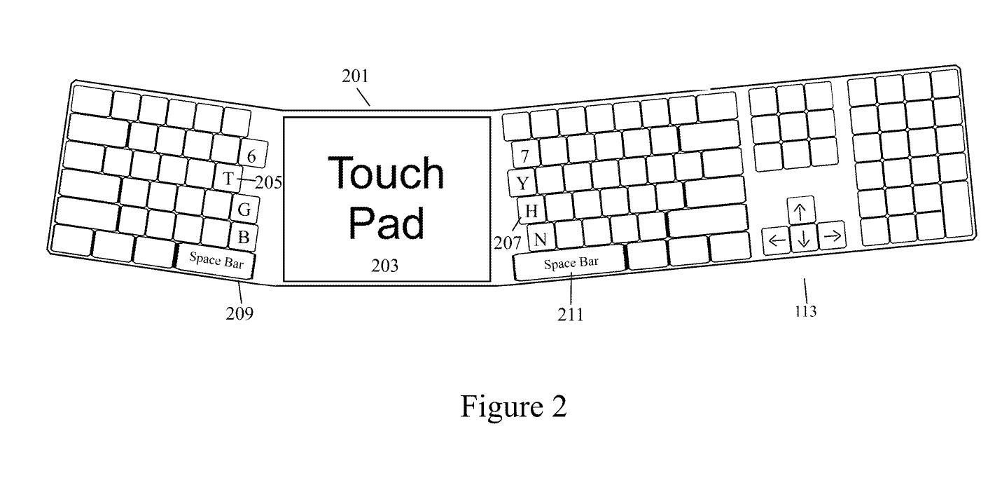

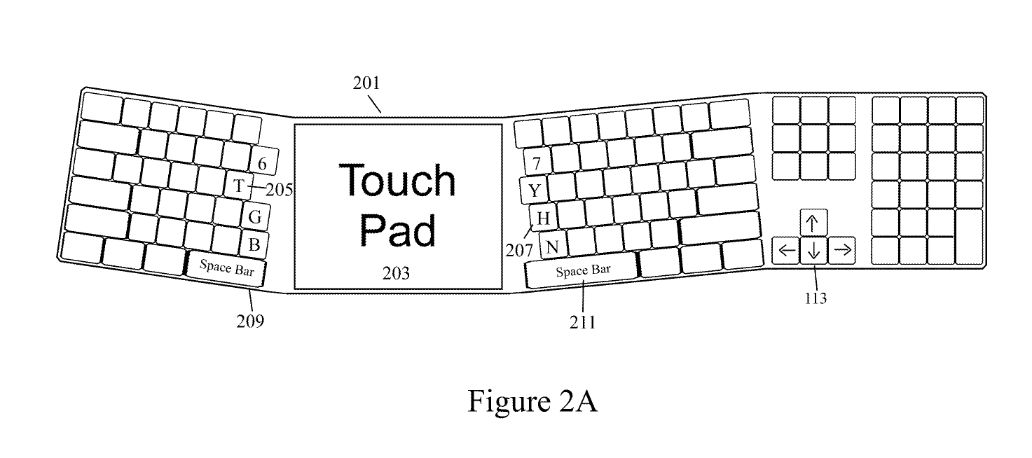

In various embodiments a keyboard with an integrated touchpad can be designed in a “straight” or standard format, as shown by way of example in FIG. 1, or in a “curved” or ergonomic format, as shown by way of example in FIG. 2 or FIG. 2A. Either format, because of the natural split between the left and right half of the keyboard where the touchpad is placed, creates a natural ergonomic position for the hands of a user. Embodiments of the present invention may be implemented as various types of keyboards such as, but not limited to, conventional keyboards, wireless keyboards, and laptop keyboards. Embodiments of the present invention are implemented on a keyboard having a generally QWERTY layout but other layout are contemplated, such as, but not limited to, AZERTY, foreign language variations of qwerty and Dvorak simplified keyboard.

FIG. 1 illustrates an exemplary straight keyboard 101 with an integrated touchpad 103, in accordance with an embodiment of the present invention. In the present embodiment keyboard 101 is split in the middle and touchpad 103 is placed between the keys of keyboard 101. Unlike current keyboard layouts with touchpads where the touchpad is placed above, to the side or below the keyboard. Keyboard 101 is divided between the keys that are controlled by the right hand and the keys that are controlled by the left hand, as in a typical ergonomically designed curved keyboard. This division in the present embodiment occurs between a left line of keys 105 comprising the 6, T, G, and B keys on the lefthand side and a right line of keys 107 comprising the 7, Y, H, and, N keys on the righthand side. The keyboard could also be split as 5, T, G, B & 6, Y, H, N, in another embodiment. The spacebar is also divided in two so that a left portion 109 of the spacebar can be reached by the left hand and a right portion 111 can be reached by the right hand. The split in keyboard 101 and the space between the left and right keys makes keyboard 101 more ergonomic than typical straight keyboards, thus creating less stress on the hands and wrists of the user. The full functionality of the touchpad will also make the use of a typical mouse unnecessary, also alleviating CTS issues associated with prolonged mouse use.

In the present embodiment, touchpad 103 is a large square touchpad. In alternate embodiments, the touchpad may be different shapes and sizes, for example without limitation, the touchpad may be a smaller square or a rectangle so that the keys of the keyboard can be closer together thus decreasing the overall size of the keyboard. In the present embodiment, the size of touchpad 103 makes mouse tracking more accurate than in smaller touchpads. The function of touchpad 103 is similar to a typical laptop touchpad. However, in the present embodiment, touchpad 103 is larger than a typical touchpad, and the left, middle and right click buttons are integrated and programmed into keys in keyboard 101. In the present embodiment, the left, middle and right click functions are controlled by either the S, D, and F keys or the J, K, and L keys, depending on the left hand or right hand preference of the user. This enables the user to keep his hands on the keys of keyboard 101 in order to use the clicking functions. In alternate embodiments various other keys may control the clicking functions of touchpad 103, such as, but not limited to arrow keys 113. In yet other embodiments, there may be separate mouse click buttons near the touchpad, for example, without limitation, below, to the side or above the touchpad.

In typical use of the present embodiment, if the user wishes to move the mouse pointer, the user can merely use his fingers or thumbs and glide across touchpad 103. This requires little movement of the users hands because of the proximity of touchpad 103 to the keys of keyboard 101. In some cases the user may only need to move one finger from keyboard 101 to operate touchpad 103. If the user is able to use his thumbs (or any fingers) to operate touchpad 103, the user may be able to keep all of his fingers on keyboard 101. Touchpad 103 and the keyboard keys are programmed to work together. When the present embodiment senses that the fingers of the user are on touchpad 103, the designated keys, S, D, and F; J, K, and L; or otherwise, automatically double and function as the mouse click keys. This solves the problem of the user having to move his hands to click on separate buttons; making this function faster and more intuitive than typical touchpads.

FIG. 2 illustrates an exemplary ergonomic keyboard 201 with an integrated touchpad 203, in accordance with an embodiment of the present invention. The present embodiment is similar to the embodiment shown by way of example in FIG. 1. However the present embodiment has a curved design to keyboard 201 adding to the ergonomic attributes of keyboard 201. In the present embodiment, keyboard 201 is split between a left line of keys 205 comprising the 6, T, G, and B keys and a right line of keys 207 comprising the 7, Y, H, and N keys. The keyboard could also be split as 5, T, G, B & 6, Y, H, N, in another embodiment. The spacebar is also split into a left portion 209 and a right portion 211. Touchpad 203 is located between left line of keys 205 and right line of keys 207. In the present embodiment touchpad 203 is large and square; however, in alternate embodiments the touchpad may be of various shapes and sizes. For example without limitation, in one embodiment the touchpad may be wedge-shaped to fill the entire space between the keys in a curved style keyboard.

The present embodiment is programmed so that specific keys on keyboard 201 control the left, middle and right click functions of touchpad 203. In the present embodiment these keys are the S, D and F keys or the J, K and L keys, depending on the preference of the user to use either his left or right hand. Various alternate embodiments may program various other keys for the left, middle and right click functions or may comprise separate buttons on the keyboard that perform these functions, for example, without limitation, below the touchpad. In typical use the present embodiment functions the same as the embodiment shown by way of example in FIG. 1.

Embodiments of the present invention provide solutions to the problems that can be caused by currently known keyboards. For example, without limitation, the user no longer needs to use a mouse, and this, along with the ergonomic design of embodiments of the present invention, can relieve discomfort in the hands and wrists, CTS and tendonitis issues. Furthermore, embodiments of the present invention are naturally ergonomic due to the spacing in the center for the touchpad. These embodiments are also more intuitive and natural to use because the touchpad is in the center, and the user merely moves his fingers over to the left or right, instead of above or below to use the touchpad. This enables the user to keep his other hand in its position, generally eliminating the problem of fumbling to find his place of the keyboard after using the touchpad.

An alternate embodiment of the present invention comprises a keyboard with a touchpad positioned below the keys of the keyboard. In this embodiment, specific keyboard keys are designated to function as buttons performing left, middle and right click functions rather than separate buttons near the touchpad, for example without limitation, the S, D, and F keys. This reduces the number of times a user must move his hand back and forth between the keys and the touchpad while typing and operating the touchpad, and in some cases, if the user can use his thumbs to operate the touchpad, the user may not have to move any of his fingers from the keyboard while using the touchpad. In another alternate embodiment a touchpad may be positioned above or to the side of the keyboard with specific keys on the keyboard functioning as the buttons for the touchpad. Other features can be implemented in various alternate embodiments, such as, but not limited to, extra programmable function keys around the edges of the touchpad, or a built in calculator above the numeric keys, or anywhere on the keyboard for that matter.

FIG. 2A illustrates an exemplary keyboard identical to FIG. 2, except the right portion of the keyboard has been straightened comprising of the arrow keys and numeric keys.

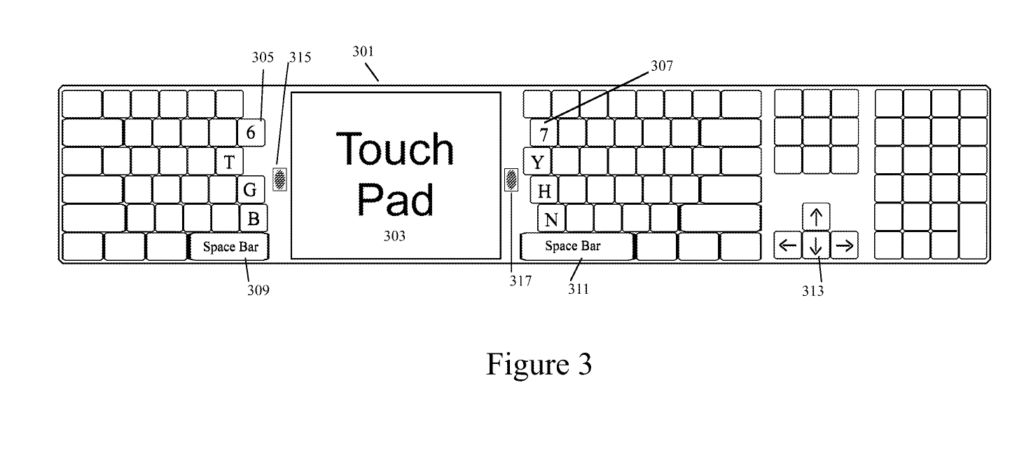

FIG. 3 illustrates an exemplary keyboard with the addition of scroll buttons in accordance with an embodiment of the present invention. Scroll buttons 315 and 317 are located near the G and H keys. Scroll buttons are placed on both sides of the keyboard in order to accommodate left and right handed users. In another embodiment the scroll button are located near the B & N, or T & Y or other location. The scroll buttons, like the scroll button on a 3 button mouse, enables the scrolling of any window from an application such as a web browser, spreadsheet or word processor. In FIG. 3, keyboard 301 has an integrated touchpad 303 in accordance with an embodiment of the present invention. In the present embodiment keyboard 301 is split in the middle and touchpad 303 is placed between the keys of keyboard 301. Space keys are present as 309 and 311 on both sides of the keyboard.

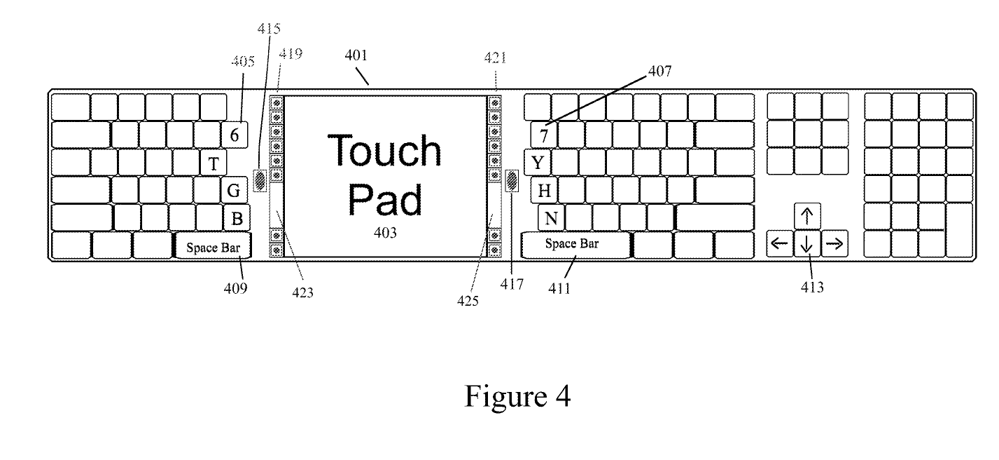

FIG. 4 illustrates an exemplary keyboard with programable function buttons in accordance with an embodiment of the present invention. In FIG. 4, programable function buttons 419 and 421 (left and right side respectively) are positioned along the sides of touchpad 403 on keyboard 401. Programable function buttons 419 and 421 may be programmed to initiate various functions in the operating system or directly in an application program. In another embodiment, these programable function buttons 419 and 421 also include scroll touchstrip pads 423 and 425 (left and right sides respectively). These touchstrip pads provides the functionality of scrolling an application window up and down by just touching and sliding along the touchstrip pad. Touchstrip pads 423 and 425 functions similarly to scroll buttons 415 and 417 and. This embodiment also has a large square touchpad 403, space buttons 409 and 411 on the left and right side of the keyboard 401.

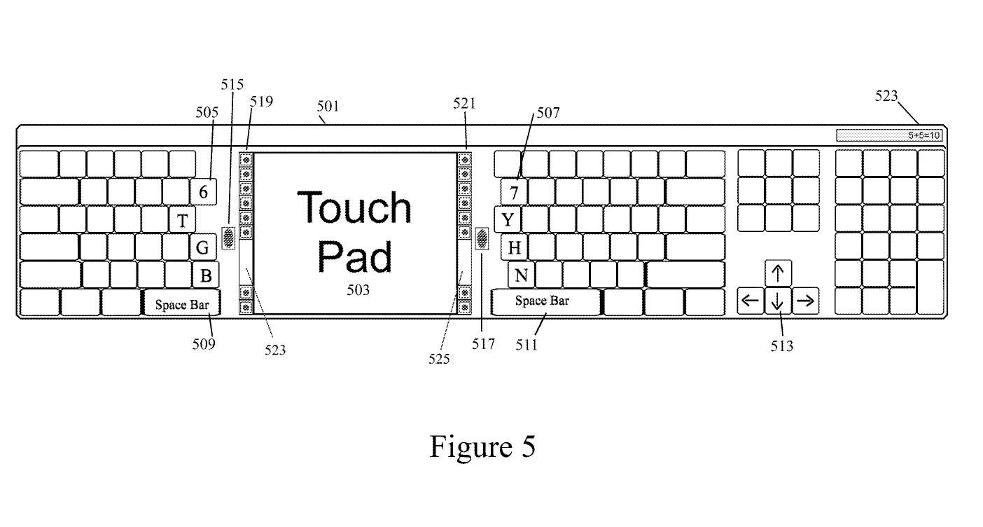

FIG. 5 illustrates an exemplary keyboard with a calculator in accordance with an embodiment of the present invention. Calculator 523 can do basic mathematical functions like any standard calculator and display the results. Keyboard 501 also incorporates a large square touchpad 503, programmable function keys 519 and 521 along the sides of the touchpad 503, touchstrip pads 523 and 525, and scroll buttons 515 and 517. Space keys 509 and 511 are located on both sides of the keyboard 501.

In other embodiments additional functions or function buttons may be add in areas, such as, but not limited to, the space area right above the keys and to the left of the calculator. These additional functions or function buttons may include, but not limited to, miscellaneous function buttons like volume control, added function keys and Universal Serial Ports (USB). Although FIGS. 3, 4 and 5 illustrate a straight keyboard, the embodiments may also be implemented in the curved ergonomic keyboard illustrated in FIGS. 2 and 2A.

Having fully described at least one embodiment of the present invention, other equivalent or alternative means for implementing a keyboard with an integrated touchpad according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A keyboard apparatus for use with a computing device, the apparatus comprising:
a plurality of alphanumeric keys grouped into at least a left group for use by a user's left hand and a right group for use by a user's right hand;
a touchpad device for controlling a movement of a cursor displayed on the computing device by a touch movement on a surface of said touchpad, said touchpad positioned between said left group and said right group for easy and intuitive access when using said alphanumeric keys; and
designated keys for activating functions on the computing device when said touch movement is controlling said cursor where minimal movement is required of said user's hands for said touch movement and said function activating.

2. The apparatus as recited in claim 1, further comprising a left spacebar key positioned left of said touchpad and a right spacebar key positioned right of said touchpad for entering spaces during alphanumeric entry into the computing device.

3. The apparatus as recited in claim 2, further comprising a left scroll button proximate a left side of said touchpad and a right scroll button proximate a right side of said touchpad for activating a scrolling function of a display on the computing device.

4. The apparatus as recited in claim 2, further comprising a left scroll touchstrip pad proximate a left side of said touchpad and a right scroll touchstrip pad proximate a right side of said touchpad for activating a scrolling function of a display on the computing device by a touch movement on said left or right scroll touchstrip pad.

5. The apparatus as recited in claim 2, further comprising programmable function buttons proximate said sides of said touchpad for activating functions on the computing device.

6. The apparatus as recited in claim 2, further comprising a calculator for performing basic mathematical functions and displaying results thereof on the apparatus.

7. The apparatus as recited in claim 2, wherein said designated keys are arrow keys.

8. The apparatus as recited in claim 2, wherein said alphanumeric keys are generally arranged in a QWERTY format.

9. The apparatus as recited in claim 8, wherein said touchpad is positioned between a left line of alphanumeric keys comprising 6, T, G, and B keys and a right line of alphanumeric keys comprising 7, Y, H, and, N keys.

10. The apparatus as recited in claim 9, wherein said designated keys are either the S, D, and F keys or the J, K, and L keys.

11. The apparatus as recited in claim 8, wherein a height of said touchpad is at least a height of rows of said alphanumeric keys.

12. The apparatus as recited in claim 11, wherein said touchpad is square.

13. The apparatus as recited in claim 2, wherein rows of said alphanumeric keys are arranged on a curve.

14. A keyboard apparatus for use with a computing device, the apparatus comprising:
means for providing a plurality of alphanumeric keys;
means for controlling a movement of a cursor displayed on the computing device by a touch movement; and means for activating functions on the computing device when said touch movement is controlling said cursor where minimal movement is required of a user's hands for said controlling means and said functions means.

15. The apparatus as recited in claim 14, further comprising means for entering spaces during alphanumeric entry into the computing device.

16. The apparatus as recited in claim 15, further comprising means for activating a scrolling function of a display on the computing device.

17. The apparatus as recited in claim 15, further comprising means for providing programmable function buttons for activating functions on the computing device.

18. The apparatus as recited in claim 15, further comprising means for performing basic mathematical functions and displaying results thereof on the apparatus.

19. A keyboard apparatus for use with a computing device, the apparatus comprising:
a plurality of alphanumeric keys generally arranged in a QWERTY format grouped into at least a left group for use by a user's left hand and a right group for use by a user's right hand;
a touchpad device for controlling a movement of a cursor displayed on the computing device by a touch movement on a surface of said touchpad, said touchpad positioned between a left line of alphanumeric keys comprising 6, T, G, and B keys and a right line of alphanumeric keys comprising 7, Y, H, and, N keys for easy and intuitive access when using said alphanumeric keys;
a left spacebar key positioned left of said touchpad and a right spacebar key positioned right of said touchpad for entering spaces during alphanumeric entry into the computing device;
a left scroll means proximate a left side of said touchpad and a right scroll means proximate a right side of said touchpad for activating a scrolling function of a display on the computing device;
programmable function buttons proximate said sides of said touchpad for activating functions on the computing device; and
designated keys for activating functions on the computing device when said touch movement is controlling said cursor where minimal movement is required of said user's hands for said touch movement and said function activating.

20. The apparatus as recited in claim 19, wherein said designated keys are either the S, D, and F keys or the J, K, and L keys.
